(19) United States
(12) Patent Application Publication
(10) Pub. No.: US 2024/0367227 A1
(43) Pub. Date: Nov. 7, 2024

(54) ADDITIVE MANUFACTURING OF PLATINUM GROUP METAL OXIDE DISPERSION STRENGTHENED ALLOYS

(71) Applicant: COOKSON PRECIOUS METALS LTD, Birmingham (GB)

(72) Inventors: Parastoo Jamshidi, Birmingham (GB); Moataz Mohammad Mahmoud Attallah, Birmingham (GB); Biao Cai, Birmingham (GB); Ian Campbell, Birmingham (GB); Selassie Dorvlo, Birmingham (GB)

(73) Assignee: COOKSON PRECIOUS METALS LTD, Birmingham (GB)

(21) Appl. No.: 18/684,741

(22) PCT Filed: Aug. 18, 2022
(86) PCT No.: PCT/EP2022/073111

§ 371 Date: Feb. 19, 2024

(30) Foreign Application Priority Data
Aug. 20, 2021 (GB) 2111954.0

(51) Int. Cl. B22F 1/00; B22F 1/05; B22F 1/142; B22F 10/28; B33Y 10/00; B33Y 70/10

(52) U.S. Cl. CPC B22F 1/09; B22F 1/05; B22F 1/142; B22F 10/28; B22F 2201/10; B22F 2301/25; B22F 2302/25; B22F 2304/10; B33Y 10/00; B33Y 70/10

(57) ABSTRACT

The present invention provides a method (1) of additively manufacturing an article comprising an oxide dispersion strengthened alloy, the method comprising: (5) providing a first powder comprising particles of one or more platinum group metals or an alloy thereof: (10) providing a second powder comprising particles of one or more non-platinum-group metals or metalloids, or one or more alloys thereof: (15) providing a third powder by mixing the first powder and the second powder, the third powder comprising from 0.01 to 1 wt. % of the second powder, based on the total weight of the third powder; and (20) forming an article by a powder bed fusion method using the third powder in an atmosphere comprising from greater than 0 to 2 mol. % oxygen.

The present invention relates to methods of additively manufacturing articles, wherein the additively manufactured article comprises an oxide dispersion strengthened alloy, and to articles manufactured thereby.

Oxide dispersion strengthened (ODS) alloys have been produced for decades due to their beneficial properties at high temperature such as strength retention and creep resistance. Depending on the literature they are also called dispersion hardened materials (e.g. DPH materials). These materials are sometimes referred to as “metal matrix composites” as they involve having a separate discrete phase sitting within the grain boundaries of the alloy, which tends to improve the material's hardness, high temperature strength and creep resistance.

For example, it is known that the addition of very small amounts of yttrium and/or zirconium to platinum alloys makes the platinum alloy structure more stable and greatly improves the recrystallization temperature. The second phase distributed does not dissolve but sits in the grain boundaries. These additions of yttrium and/or zirconium improve the properties of platinum at both room and elevated temperatures. Moreover, alloying with both of yttrium and zirconium is more effective than alloying only with zirconium, for example. Further improvements in dispersion hardening of the platinum is also made by oxidising the elemental yttrium and or zirconium.

For example, ODS platinum alloys are known in the art. These are particularly useful in high temperature applications, due to having excellent chemical resistance, particularly to high temperature oxidation, with retention of mechanical properties at high temperature and improved creep resistance.

Platinum alloys, i.e. non-ODS platinum alloys, are used in high temperature applications, such as for bushings for glass fibre production. It would be desirable to additively manufacture the platinum alloys to make complex parts for these high temperature applications, such as for bushings for glass fibre production, for example. However, there is a desire to increase the working lifetime of such alloys used in high temperature applications, such as for bushings for glass fibre production. This is because the turnover of traditional components during the glass production process, for example, is high. For example, a traditionally manufactured bushing (i.e. not made by additive manufacturing, often a complex product joined by welding) may typically need to be replaced after from anywhere between 3 and 300 days of service.

The inventors have surprisingly identified that ODS platinum alloys may be useful for similar applications, but there is currently no known method for additively manufacturing such materials. Additively manufactured ODS platinum alloys may be of much greater benefit than traditionally manufactured ODS platinum alloys due to the ability to manufacture parts with complex shapes and internal structures, for example, while also having the benefit of the increased hardness, high temperature strength and creep resistance of the material.

Conventional additive manufacturing methods for platinum group metal (PGM) alloys are well known in the art. However, additively manufactured ODS PGM alloys are not known.

Accordingly, there is a need to provide a method of additively manufacturing a material for high temperature applications, wherein the additively manufactured material has improved high temperature properties, such as hardness, high temperature strength and creep resistance, compared to additively-manufactured pure-PGM alloys.

The present invention seeks to tackle at least some of the problems associated with the prior art or at least to provide a commercially acceptable alternative solution thereto.

The present invention provides methods of additively manufacturing articles comprising an oxide dispersion strengthened alloy, an additively manufactured article and a bushing for glass fibre production according to the claims appended hereto.

Specifically, in one aspect the present invention provides a method of additively manufacturing an article comprising an oxide dispersion strengthened alloy, the method comprising:
providing a first powder comprising particles of one or more platinum group metals or an alloy thereof;
providing a second powder comprising particles of one or more non-platinum-group metals or metalloids, or one or more alloys thereof;
providing a third powder by mixing the first powder and the second powder, the third powder comprising from 0.01 to 1 wt. % of the second powder, based on the total weight of the third powder; and
forming an article by a powder bed fusion method using the third powder in an atmosphere comprising from greater than 0 to 2 mol. % oxygen.

Each aspect or embodiment as defined herein may be combined with any other aspect(s) or embodiment(s) unless clearly indicated to the contrary. In particular, any features indicated as being preferred or advantageous may be combined with any other feature indicated as being preferred or advantageous.

The term “additive manufacturing” as used herein is well known in the art and holds its usual meaning. More specifically, the term “additive manufacturing” as used herein may encompass a method in which a 3-dimensional object is obtained by adding material layer by layer to form the final product. Additive manufacturing may also be known as “3D printing”.

The term “oxide dispersion strengthened alloy” (ODSA) as used herein is well known in the art and holds its usual meaning. More specifically, the term “oxide dispersion strengthened alloy” as used herein may encompass a metal matrix comprising (small) oxide particles dispersed therein. Advantageously, the oxide particles enhance high temperature strength and suppress grain growth, thereby making it possible to have long-term stable characteristics. Without wishing to be bound by theory, it is generally understood that the oxide particles are incoherent with the lattice of the material and thereby decrease movement of dislocations. This, in turn, may prevent creep.

The terms “first powder”, “second powder”, “third powder” etc. as used herein are used as labels and, unless otherwise specified, do not indicate relative positions or the order in which the powders must be provided.

The term “platinum group metal” (PGM) as used herein encompasses the elements ruthenium (Ru), rhodium (Rh), palladium (Pd), osmium (Os), iridium (Ir) and platinum (Pt), as is generally understood in the art. Accordingly, the term “non-platinum-group metal” encompasses any metal element other than the PGMs. In other words, the term “non-platinum-group metal” encompasses any metal element other than ruthenium (Ru), rhodium (Rh), palladium (Pd), osmium (Os), iridium (Ir) and platinum (Pt).

The term “metalloid” as used herein encompasses the elements boron, silicon, germanium, arsenic, antimony, tellurium, and polonium, as is common in the art.

The term “blend” as used herein may encompass a combination of two or more materials (for example PGMs) which are mixed, but not in alloy form. The term “alloy” as used herein holds its usual meaning in the art.

Unless otherwise stated, the term “mol. % oxygen” as used herein means mol. % of molecular oxygen.

The term “powder bed fusion” as used herein is well known in the art and holds its usual meaning. In particular, the term “powder bed fusion” may encompass a method in which a laser or electron beam, for example, is used to melt and fuse material powder together, layer by layer in an additive manufacturing process, in order to obtain a final 3-dimensional product. Common powder bed fusion processes include, but are not limited to, direct metal laser sintering (DMLS), electron beam melting (EBM), selective heat sintering (SHS), selective laser melting (SLM) and selective laser sintering (SLS). Alternatively, a directed energy deposition (DED) process, such as direct laser deposition (DLD), may be suitable for use in the method of the invention, i.e. as an alternative to the powder bed fusion method. SLM is typically and preferably used in the present invention. However, other methods may be used depending on the purpose of the final article and/or the materials used, for example. All of the described processes are well known in the art and the parameters used therein may be adjusted as appropriate by the person skilled within the field during routine use.

The Inventors have surprisingly found that forming the article by a powder bed fusion method in an atmosphere comprising from greater than 0 to 2 mol. % oxygen enables a PGM-based ODSA that is not brittle and is suitable for high temperature applications to be formed by additive manufacturing, where this has previously not been possible for PGM-based ODSAs. Without wishing to be bound by theory, it is thought that this may be because the method enables the oxides of the one or more non-platinum-group metals or metalloids to be evenly dispersed throughout the article, since the oxides are created in situ, layer by layer during the additive manufacturing process. This new method advantageously has many promising applications in a wide range of fields in which the article will need to withstand high temperatures while preferably having a complex design. Such a method has not been contemplated or previously investigated for use with PGMs before now. The additively manufactured PGM-based ODSA articles provide a significant improvement for use in high temperature applications compared to the additively manufactured articles currently used, which are typically made from simple PGM alloys. The method of the present invention also advantageously enables the PGM-based ODSA articles to be formed into complex shapes, which has not previously been possible on a large scale for PGM-based ODSAs, without requiring significant labour in producing bespoke articles, for example. The additively manufactured articles described herein may therefore have a longer lifetime during such high temperature applications.

The method comprises providing a first powder comprising particles of one or more PGMs or an alloy thereof. The particles of one or more PGMs may be in the form of a blend, i.e. a combination of two or more PGMs that are mixed, but not in alloy form. The PGM alloy may comprise at least one PGM and any other element suitable for forming an alloy therewith. However, preferably the PGM alloy consists of two or more PGMs. Preferably, the first powder comprises particles of a Pt-based PGM alloy, i.e. a PGM alloy comprising Pt as the most abundant element. The first powder preferably consists essentially of particles of one or more PGMs or an alloy thereof and more preferably consists of particles of one or more PGMs or an alloy thereof. The term “consists essentially of” as used herein may encompass a material in which, in addition to those elements that are mandatory, other non-specified elements may be present in the composition provided that the essential characteristics of the composition are not materially affected by their presence. It has been found that such a choice of elemental composition for the first powder enables an additively manufactured article to be formed which has the most optimised properties for high temperature applications, while also considering costs.

It will be appreciated that unavoidable impurities may be present in the first powder. However, such impurities will typically be present in an amount of less than 1 wt. %, preferably less than 0.5 wt. %, more preferably less than 0.2 wt. %, even more preferably less than 0.1 wt. % or even more preferably less than 0.01 wt. %, based on the total weight of the first powder. Most preferably, the first powder is free of impurities within practical limits.

The method comprises providing a second powder comprising particles of one or more non-platinum-group metals or metalloids, or one or more alloys thereof. In general, the one or more non-platinum-group metals or metalloids, or one or more alloys thereof should have a lower oxidation temperature (i.e. temperature at which the metal or metalloid will oxidise when heated in an atmosphere containing oxygen) than the one or more PGMs or alloy thereof of the first powder. Preferably, the second powder comprises particles of one or more of cerium, tungsten, tantalum, hafnium, manganese, thorium, calcium, aluminium, zirconium and yttrium, or one or more alloys thereof. More preferably, the second powder comprises particles of zirconium and/or yttrium and/or an alloy thereof and even more preferably comprises particles of zirconium and yttrium. In an alternative preferred embodiment, the second powder comprises particles of cerium and zirconium, or an alloy thereof. Although the invention may be performed with any of the listed elements for the second powder, it has surprisingly been found that the best improvement in hardness and creep resistance compared to the respective one or more PGMs or alloy thereof comes from the use of zirconium and/or yttrium (i.e. zirconia and/or yttria being the oxides in the resulting ODSA, that is zirconia, yttria or yttria-stabilised zirconia, for example) and also that zirconium and/or yttrium work most effectively in the method of the present invention (i.e. to form evenly dispersed oxides within the final article), and particularly zirconium and yttrium in combination, most preferably an alloy thereof. Use of a combination of cerium and zirconium may also be effective.

The second powder preferably consists essentially of particles of one or more non-platinum-group metals or metalloids, or one or more alloys thereof and more preferably consists of particles of one or more non-platinum-group metals or metalloids, or one or more alloys thereof. The second powder may be in the form of single metal particles, for example of each of the elements respectively, and/or particles in the form of a blend or alloy thereof.

It will be appreciated that unavoidable impurities may be present in the second powder. However, such impurities will typically be present in an amount of less than 1 wt. %, preferably less than 0.5 wt. %, more preferably less than 0.2 wt. %, even more preferably less than 0.1 wt. % or even more preferably less than 0.01 wt. %, based on the total weight of the second powder. Most preferably, the second powder is free of impurities within practical limits.

The method comprises providing a third powder by mixing the first powder and the second powder. Preferably, the third powder consists essentially of the first powder and the second powder and more preferably consists of the first powder and the second powder. It will be appreciated that unavoidable impurities may be present in the third powder. However, such impurities will typically be present in an amount of less than 1 wt. %, preferably less than 0.5 wt. %, more preferably less than 0.2 wt. %, even more preferably less than 0.1 wt. % or even more preferably less than 0.01 wt. %, based on the total weight of the third powder. Most preferably, the third powder is free of impurities within practical limits. The third powder is provided by mixing the first powder and the second powder and it has been found that the more evenly dispersed the second powder is within the first powder as a result of the mixing, then the more evenly dispersed the resulting oxides are within the additively manufactured article that may be formed, thereby resulting in an article which may be more likely to exhibit the above-described advantageous properties for high temperature applications. Thus, preferably, the third powder is homogeneous in that it comprises the second powder evenly dispersed within the first powder.

The third powder comprises from 0.01 to 1 wt. % of the second powder based on the total weight of the third powder, such as from 0.01 to 1.0 wt. % of the second powder. Preferably, the third powder comprises from 0.01 to 0.9 wt. % of the second powder, more preferably from 0.01 to 0.8 wt. %, even more preferably from 0.01 to 0.7 wt. %. In some preferred embodiments, the third powder comprises from 0.5 to 1.0 wt. % of the second powder, preferably from 0.6 to 0.9 wt. %, more preferably from 0.65 to 0.75 wt. %, even more preferably about 0.7 wt. %. In other preferred embodiments, the third powder comprises from 0.01 to 0.1 wt. % of the second powder, preferably from 0.01 to 0.05 wt. % of the second powder, preferably from 0.01 to 0.04 wt. % of the second powder, most preferably about 0.015 wt. % of the second powder, based on the total weight of the third powder. Alternatively, the third powder preferably comprises from 0.01 to 0.05 wt. % of the second powder, preferably from 0.02 to 0.04 wt. % of the second powder, even more preferably about 0.03 wt. % of the second powder, based on the total weight of the third powder. It has surprisingly been found that such a weight ratio between the first powder and the second powder advantageously provides for a method in which an additively manufactured article can be manufactured with the most beneficial high-temperature properties, such as hardness, strength and creep resistance. For example, a benefit in tensile strength has been observed with a third powder comprising about 0.7 wt. % yttria.

The method comprises forming an article by a powder bed fusion method using the third powder in an atmosphere comprising from greater than 0 to 2 mol. % oxygen. Accordingly, during the powder bed fusion method using the third powder in an atmosphere comprising from greater than 0 to 2 mol. % oxygen, the particles of one or more non-platinum-group metals or metalloids, or one or more alloys thereof are typically at least partially oxidised in situ. Preferably, the powder bed fusion method is selective laser melting. Methods of selective laser melting are well known in the art. The parameters used therein may be adjusted as appropriate by the person skilled within the field during routine use. Without wishing to be bound by theory, it is thought that performing the powder bed fusion method in such a poisoned atmosphere comprising from greater than 0 to 2 mol. % oxygen enables the oxides of the one or more non-platinum-group metals or metalloids to be evenly dispersed throughout the article, since the oxides are created in situ, layer by layer during the additive manufacturing process. Thus, an additively manufactured article may be formed that possesses advantageously high and homogeneously distributed hardness, strength and creep resistance.

The atmosphere may comprise from 0.01 to 2 mol. % oxygen, for example. Preferably, the atmosphere comprises from 0.05 to 2 mol. % oxygen, more preferably from 0.1 to 2 mol. % oxygen, still more preferably from 0.5 to 1.5 mol. % oxygen and most preferably from 0.7 to 1.3 mol. % oxygen. It has surprisingly been found that such oxygen concentrations enable the oxides of the one or more non-platinum-group metals or metalloids to be formed in situ, while reducing the risk that any of the PGMs are also oxidised. Without wishing to be bound by theory, it is thought that this is because, for example, the preferred elements cerium, tungsten, tantalum, hafnium, manganese, thorium, calcium, aluminium, zirconium and/or yttrium are more susceptible to oxidation under the conditions of the method. Preferably, the atmosphere consists of oxygen and one or more of nitrogen and argon, together with any unavoidable impurities, to provide an otherwise inert atmosphere (i.e. other than the oxygen present).

The method may further comprise a step of recovering the additively manufactured article. For example, the method may further comprise a step of recovering the additively manufactured article from the powder bed fusion apparatus, such as by retrieving the additively manufactured article from the remaining powder which has not been sintered and/or melted during the process.

Such a step will be well known to those skilled in the field.

In a further aspect, the present invention provides a method of additively manufacturing an article comprising an oxide dispersion strengthened alloy, the method comprising:
providing a first powder comprising particles of one or more platinum group metals or an alloy thereof;
providing a second powder comprising particles of one or more non-platinum-group metals or metalloids, or one or more alloys thereof;
providing a third powder by mixing the first powder and the second powder, the third powder comprising from 0.01 to 1 wt. % of the second powder, based on the total weight of the third powder;
providing an activated powder by heating the third powder in an atmosphere comprising from greater than 0 to 2 mol. % oxygen to a temperature sufficient to cause at least partial oxidation of the one or more non-platinum-group metals or metalloids, or one or more alloys thereof, but substantially no oxidation of the one or more platinum group metals or alloy thereof; and
forming an article by a powder bed fusion method using the activated powder in an inert atmosphere.

It will be appreciated that the definitions and preferences outlined above in relation to the first aspect apply equally to this aspect, where appropriate.

Alternatively to the method of the first aspect, the method of the present aspect comprises providing an activated powder by heating the third powder in an atmosphere comprising from greater than 0 to 2 mol. % oxygen to a temperature sufficient to cause at least partial oxidation of the one or more non-platinum-group metals or metalloids, or one or more alloys thereof, but substantially no oxidation of the one or more platinum group metals or alloy thereof. The method of the present aspect may therefore provide an alternative solution for obtaining the evenly dispersed oxides within the additively manufactured article. Although the method of the first aspect is preferred, as it may more reliably achieve the homogeneous dispersion of the oxides within the additively manufactured article, the method of the present aspect still overcomes the problems associated with the prior art by obtaining an additively manufactured PGM-based ODSA in which the oxides may be more evenly distributed, such that an article with advantageous high temperature properties may be formed.

The atmosphere may comprise from 0.01 to 2 mol. % oxygen, for example. Preferably, the atmosphere comprises from 0.05 to 2 mol. % oxygen, more preferably from 0.1 to 2 mol. % oxygen, still more preferably from 0.5 to 1.5 mol. % oxygen and most preferably from 0.7 to 1.3 mol. % oxygen.

The third powder is provided by mixing the first powder and the second powder and it has been found that the more evenly dispersed the second powder is within the first powder, then the more likely it may be that the oxides formed within the activated powder during the heating step will be more evenly dispersed before the step of forming the article using the activated powder. Thus, it may be more likely that the oxides in the additively manufactured article will be more evenly dispersed. Accordingly, the third powder is preferably homogeneous in that it comprises the second powder evenly dispersed within the first powder. As will be appreciated, in practice small particle sizes of the third powder may result in the activated powder comprising small amounts of oxidised PGM. However, typically the activated powder comprises substantially no oxidised PGM, such as less than 0.1 wt. %, based on the total weight of the activated powder. The activated powder may preferably comprise less than 0.05 wt. % oxidised PGM, more preferably less than 0.01 wt. % oxidised PGM based on the total weight of the activated powder.

The activated powder therefore comprises oxides of one or more non-platinum-group metals or metalloids, for example oxides of one or more of cerium, tungsten, tantalum, hafnium, manganese, thorium, calcium, aluminium, zirconium and yttrium, dispersed within the particles of the one or more PGMs or alloy thereof from the first powder. However, it will be appreciated that not all of the one or more non-platinum-group metals or metalloids, or one or more alloys thereof within third powder may fully oxidise. That is, the term “at least partial oxidation” as used herein may encompass a process in which at least a portion of the one or more non-platinum-group metals or metalloids, or one or more alloys thereof forms oxides of the elements comprised therein, respectively. Thus, small amounts of one or more non-platinum-group metals or metalloids, or one or more alloys thereof, for example cerium, tungsten, tantalum, hafnium, manganese, thorium, calcium, aluminium, zirconium and/or yttrium metals, may be present in the activated powder. Preferably, greater than 50 wt. % of the one or more non-platinum-group metals or metalloids, or one or more alloys thereof (e.g. cerium, tungsten, tantalum, hafnium, manganese, thorium, calcium, aluminium, zirconium and/or yttrium) are oxidised in the activated powder, more preferably greater than 70 wt. %, even more preferably greater than 80 wt. % and still more preferably greater than 90 wt. %, based on the total weight of the activated powder.

Preferably, the third powder is heated to a temperature of from 400° C. to 950° C. for 2 hours or less, preferably from 500° C. to 950° C. for 2 hours or less. The preferred temperature may vary depending on the elements comprising the first and second powders.

Preferably, the third powder is heated for 1 hour or less, for example for from 10 seconds to 1 hour, more preferably, the third powder is heated for from 10 second to 30 minutes. In some embodiments, the third powder is heated for 2 minutes or less, such as for from 30 second to 90 seconds. In other words, the third powder is heated for a time sufficient to cause at least partial oxidation of the one or more non-platinum-group metals or metalloids, or one or more alloys thereof, but substantially no oxidation of the one or more PGMs or alloy thereof.

Thereafter, the method of the present aspect comprises forming an article by a powder bed fusion method using the activated powder in an inert atmosphere, i.e. a conventional powder bed fusion method, but wherein the powder already comprises oxides of one or more non-platinum-group metals or metalloids, for example cerium, tungsten, tantalum, hafnium, manganese, thorium, calcium, aluminium, zirconium and/or yttrium. The inert atmosphere typically consists of nitrogen and/or argon, together with any unavoidable impurities. As described above, because the oxides may be evenly distributed within the activated powder, the oxides may consequently be evenly distributed within the PGM-based ODSA. As a result, the advantageous properties of the additively manufactured article described above in relation to the first aspect may also be achieved by the method of the present aspect. Without wishing to be bound by theory, the above reasoning applies, mutatis mutandis, to the method of the present aspect.

The method of any aspect may further comprise a heat treatment step. The heat treatment step preferably comprises treating the article (i.e. the article formed by the method of the invention) at a temperature of from 200 to 1600° C. in an atmosphere comprising from greater than 0 to 2 mol. % oxygen for from 1 to 20 hours, such as at a temperature of about 1200° C. for about 10 hours in a furnace in an atmosphere consisting of about 0.5 mol. % oxygen and the balance argon, together with any unavoidable impurities. Without wishing to be bound by theory, it is thought that the additional heat treatment step may cause further oxidation of the grain refiner (i.e. the elements of the second powder, e.g. yttrium and zirconium), in case the grain refiner is not fully oxidised in situ, for example.

Preferably, in the method of the first two aspects disclosed herein the particles of the second powder have a D90 of 10 μm or less. As will be appreciated by a person skilled in the art, the D90 refers to the value at 90% in the cumulative size distribution. The D90 is based on a volume basis. Typically, the D90 may be measured on a number basis and converted to a volume basis. The D90 may be measured by laser diffraction, for example. Suitable laser diffraction methods are known to those skilled in the field. In some embodiments, the particles of the second powder have a D90 of from 0.1 to 10 μm, for example. Preferably, the particles of the second powder have a D90 of 5 μm or less, more preferably 3 μm or less, even more preferably 1 μm or less. For example, the particles of the second powder may have a D90 of from 0.1 to 5 μm, preferably from 0.1 to 3 μm, more preferably from 0.1 to 1 μm. The particles of the second powder may also have a D90 of, for example, from 0.5 to 10 μm, preferably from 0.5 to 5 μm, more preferably from 0.5 to 3 μm, even more preferably from 0.5 to 1 μm. Without wishing to be bound by theory, it is thought that such a particle size distribution may enable the second powder to be more evenly distributed within the first powder to form the third powder, thereby helping to obtain an additively manufactured article with the above-described advantageous properties at high temperatures for at least the same reasons as described above. Without wishing to be bound by theory, this may be particularly advantageous, for example, in the method of the alternative aspect because the smaller particle sizes of the particles of the second powder means that the surface area to volume ratio of the particles is increased. Accordingly, this may in turn enable a higher weight percentage of the material from the second powder to be oxidised in the heating step. Accordingly, improved distribution of the oxides within the additively manufactured articles may be achieved compared to that which conventional methods may achieve, in which the materials may be mixed in bulk.

In a further aspect, the present invention provides a method of additively manufacturing an article comprising an oxide dispersion strengthened alloy, the method comprising:
providing a first powder comprising particles of one or more platinum group metals or an alloy thereof;
providing an oxide powder comprising particles of one or more oxides of a or a mixture of non-platinum-group metals or metalloids;
providing a mixed powder by mixing the first powder and the oxide powder, the mixed powder comprising from 0.01 to 1 wt. % of the oxide powder, based on the total weight of the mixed powder; and
forming an article by a powder bed fusion method using the mixed powder in an inert atmosphere.

It will be appreciated that the definitions and preferences outlined above in relation to the first and second aspects apply equally to this aspect, where appropriate.

Alternatively to the method of the first and second aspects, the method of the present aspect comprises providing an oxide powder comprising particles of one or more oxides of a or a mixture of non-platinum-group metals or metalloids. That is, the method of the present aspect involves providing particles of a pre-formed oxide, rather than forming the oxide(s) in situ. Accordingly, in this aspect it may be important that the mixed powder is well mixed. Thus, preferably, the mixed powder is homogeneous, as described herein with respect to the third powder. Preferably, the method comprises mixing or blending the mixed powder, preferably in a mill, more preferably in a ball or rod mill, even more preferably in a ball mill. The mixed powder is preferably mixed or blended for from 1 to 60 minutes, preferably for from 20 to 40 minutes, even more preferably for about 30 minutes. The inventors have surprisingly found that such mixing or blending may be particularly important for this aspect, for assisting in avoiding localised regions of oxide, for example. Accordingly, it may be possible to form an additively manufactured ODSA article that is not brittle, for example, and has high hardness and tensile strength. In other words, it is surprising that such an article can be additively manufactured in this way. The inventors have surprisingly identified such a new additive manufacturing method using these starting materials.

The method of the present aspect may therefore provide an alternative solution for obtaining the evenly dispersed oxides within the additively manufactured article. The method of this aspect may be understood as an alternative method to the second aspect, for example, but wherein the powder containing the mixture of the first powder and the one or more oxides of the one or more non-platinum-group metals or metalloids, for example, is not formed in situ but is formed by mixing the first powder and a pre-formed oxide powder.

The methods of the first and second aspects described above may be preferred, since they may more reliably achieve the homogeneous dispersion of the oxides within the additively manufactured article. However, the method of this aspect may also be suitable. Although the method of the first and second aspects described above may be preferred, the method of the present aspect may still overcome the problems associated with the prior art by obtaining an additively manufactured PGM-based ODSA in which the oxides may be more evenly distributed, such that an article with advantageous high temperature properties may be formed.

Preferably, the particles of the oxide powder have a D90 of 10 μm or less. The D90 may be measured by laser diffraction, for example. Suitable laser diffraction methods are known to those skilled in the field. In some embodiments, the particles of the oxide powder have a D90 of from 0.01 to 10 μm, such as from 0.1 to 10 μm, for example. Preferably, the particles of the oxide powder have a D90 of 5 μm or less, more preferably 3 μm or less, even more preferably 1 μm or less. For example, the particles of the oxide powder may have a D90 of from 0.01 to 5 μm, preferably from 0.1 to 3 μm, more preferably from 0.1 to 1 μm. The particles of the oxide powder may also have a D90 of, for example, from 0.5 to 10 μm, preferably from 0.5 to 5 μm, more preferably from 0.5 to 3 μm, even more preferably from 0.5 to 1 μm. Without wishing to be bound by theory, it is thought that such a particle size distribution may enable the oxide powder to be more evenly distributed within the first powder to form the mixed powder, thereby helping to obtain an additively manufactured article with the above-described advantageous properties at high temperatures for at least the same reasons as described above.

The method comprises providing an oxide powder comprising particles of one or more oxides of a or a mixture of non-platinum-group metals or metalloids. Preferably, the oxide powder comprises particles of one or more oxides of a or a mixture of cerium, tungsten, tantalum, hafnium, manganese, thorium, calcium, aluminium, zirconium and yttrium. Preferably, the oxide powder comprises one or more of cerium oxide, zirconium oxide, yttrium oxide, a zirconium-yttrium mixed oxide and a cerium-zirconium mixed oxide. Such oxides may provide particularly advantageous additively manufactured PGM-based ODSAs as described herein.

The oxide powder preferably consists essentially of particles of one or more oxides of a or a mixture of non-platinum-group metals or metalloids, and more preferably consists of particles of one or more oxides of a or a mixture of non-platinum-group metals or metalloids.

It will be appreciated that unavoidable impurities may be present in the oxide powder. However, such impurities will typically be present in an amount of less than 1 wt. %, preferably less than 0.5 wt. %, more preferably less than 0.2 wt. %, even more preferably less than 0.1 wt. % or even more preferably less than 0.01 wt. %, based on the total weight of the oxide powder. Most preferably, the oxide powder is free of impurities within practical limits.

The method comprises providing a mixed powder by mixing the first powder and the oxide powder. Preferably, the mixed powder consists essentially of the first powder and the oxide powder and more preferably consists of the first powder and the oxide powder. It will be appreciated that unavoidable impurities may be present in the mixed powder. However, such impurities will typically be present in an amount of less than 1 wt. %, preferably less than 0.5 wt. %, more preferably less than 0.2 wt. %, even more preferably less than 0.1 wt. % or even more preferably less than 0.01 wt. %, based on the total weight of the mixed powder. Most preferably, the mixed powder is free of impurities within practical limits. The mixed powder is provided by mixing the first powder and the oxide powder and it has been found that the more evenly dispersed the oxide powder is within the first powder as a result of the mixing, then the more evenly dispersed the resulting oxides are within the additively manufactured article that may be formed, thereby resulting in an article which may be more likely to exhibit the above-described advantageous properties for high temperature applications. Thus, preferably, the mixed powder is homogeneous in that it comprises the oxide powder evenly dispersed within the first powder.

The mixed powder comprises from 0.01 to 1 wt. % of the oxide powder based on the total weight of the mixed powder, such as from 0.01 to 1.0 wt. % of the oxide powder. Preferably, the mixed powder comprises from 0.01 to 0.9 wt. % of the oxide powder, more preferably from 0.01 to 0.8 wt. %, even more preferably from 0.01 to 0.7 wt. %. In some preferred embodiments, the mixed powder comprises from 0.5 to 1.0 wt. % of the oxide powder, preferably from 0.6 to 0.9 wt. %, more preferably from 0.65 to 0.75 wt. %, even more preferably about 0.7 wt. %. In other preferred embodiments, the mixed powder comprises from 0.01 to 0.1 wt. % of the oxide powder, preferably from 0.01 to 0.05 wt. % of the oxide powder, preferably from 0.01 to 0.04 wt. % of the oxide powder, most preferably about 0.015 wt. % of the oxide powder, based on the total weight of the mixed powder. Alternatively, the mixed powder preferably comprises from 0.01 to 0.05 wt. % of the oxide powder, preferably from 0.02 to 0.04 wt. % of the oxide powder, even more preferably about 0.03 wt. % of the oxide powder, based on the total weight of the mixed powder. It has surprisingly been found that such a weight ratio between the first powder and the oxide powder advantageously provides for a method in which an additively manufactured article can be manufactured with the most beneficial high-temperature properties, such as hardness, strength and creep resistance. For example, a benefit in tensile strength has been observed with a mixed powder comprising about 0.7 wt. % yttria.

Preferably, the method of any aspect disclosed herein further comprises a step of forming the first powder by atomizing one or more PGMs or an alloy thereof. Suitable atomization techniques are known in the art. As a result, a first powder is provided with a preferred particle size distribution. For example, the first powder may have a D90 of 90 μm or less, such as 70 μm or less, preferably 60 μm or less, even more preferably 54 μm or less. The first powder may also have a D10 of 5 μm or more, such as 10 μm or more, preferably 15 μm or more. Without wishing to be bound by theory, it is though that such a particle size distribution may enable even distribution the second or oxide powder within the first powder, thereby contributing to the advantageous effects described herein. Thus, preferably the particles of the first powder have a D90 of 60 μm or less and the particles of the second or oxide powder have a D90 of 5 μm or less in combination.

Preferably, the one or more PGMs comprises, or more preferably consists essentially of or even consists of platinum, together with any unavoidable impurities. Preferably the one or more PGMs or alloy thereof is a PGM alloy and preferably comprises, or more preferably consists essentially of or even consists of, platinum and one or more of rhodium, ruthenium and iridium, together with any unavoidable impurities. In some embodiments the platinum group metal alloy comprises, or more preferably consists essentially of or even consists of: from 0.5 to 30 wt. % rhodium, preferably 2 to 30 wt. % rhodium, more preferably 5 to 30 wt. % rhodium, even more preferably from 2 to 15 wt. % or from 5 to 15 wt. % rhodium, still more preferably from 8 to 12 wt. % rhodium, still more preferably about 10 wt. % rhodium; and the balance platinum, together with any unavoidable impurities. In other embodiments the platinum group metal alloy comprises, or more preferably consists essentially of or even consists of: from 0.5 to 30 wt. % ruthenium, preferably 2 to 30 wt. % ruthenium; and the balance platinum, together with any unavoidable impurities. In yet other embodiments the platinum group metal alloy comprises, or more preferably consists essentially of or even consists of: from 0.5 to 30 wt. % iridium, preferably 2 to 30 wt. % iridium; and the balance platinum, together with any unavoidable impurities. In still other embodiments the platinum group metal alloy comprises, or more preferably consists essentially of or even consists of: from 0.5 to 15 wt. % iridium; from 0.5 to 15 wt. % rhodium, preferably 2 to 15 wt. % iridium and 2 to 15 wt. % rhodium; and the balance platinum, together with any unavoidable impurities. It has been surprisingly found that the above exemplary PGM alloys enable the PGM-based ODSA additively manufactured articles with the most improved high-temperature properties, such as high hardness, strength and creep resistance, to be formed.

Preferably, the third powder is provided by mixing the first powder and the second powder in a powder mixer, preferably for at least 30 minutes. Similarly, preferably the mixed powder is provided by mixing the first powder and the oxide powder in a powder mixer, preferably for at least 30 minutes. Suitable powder mixers include a tubular mixer or a ball mill, for example. Preferably, the third or mixed powder is provided by mixing the first powder and the second or oxide powder for from 30 minutes to 12 hours, more preferably for from 1 hour to 6 hours, even more preferably for from 2 to 4 hours. Without wishing to be bound by theory, it is thought that such a mixing process may enable a sufficiently evenly mixed (or homogeneous) powder to be provided, which may thereby help to achieve the advantageous effects described herein in relation to the additively manufactured article.

In some embodiments, the article is a bushing for glass fibre production. The term “bushing” may encompass, for example, a component comprising a plurality of nozzles through which molten glass may flow. The nozzles may be configured such that when molten glass is poured into each nozzle, the molten glass may be directed out of a hole in the bottom of the nozzle. However, the shape and/or structure of the glass fibre bushing is not particularly limited and may take any shape known to those skilled in the field, for example. Glass fibre bushings are well known to those skilled in the field.

In some embodiments, the article is for high-temperature applications. The articles described herein are particularly suited to such applications due to their high hardness, strength and creep resistance at high temperatures, as well as their ability to be manufactured into complex and specifically engineered shapes. Examples of high temperature applications include glass fibre production and space thruster nozzles, for example.

It should be understood, however, that the methods of the present invention are not limited to oxide dispersion strengthened alloys. For example, each aspect or embodiment as defined herein may also be used to make other dispersion-strengthened alloys. Examples of other dispersion-strengthened alloys for which the present invention may apply include oxide, carbide, silicide, and nitride dispersion strengthened alloys or combinations thereof, for example. In such methods, instead or in addition to oxygen in the poisoned inert atmosphere, the atmosphere may comprise nitrogen and/or carbon dioxide, for example, in equivalent amounts to the oxygen described in the aspects and embodiments above.

In a further aspect, the present invention provides an additively manufactured article manufactured by a method as described herein. The benefits of such an article are as described throughout the specification.

In a further aspect, the present invention provides a bushing for glass fibre production comprising an additively manufactured article as described herein.

In a further aspect, the present invention provides a bushing for glass fibre production comprising a platinum-group-metal-based oxide dispersion strengthened alloy, wherein the bushing is a continuous article. In other words, in a further aspect the present invention provides a bushing for glass fibre production comprising a platinum-group-metal-based oxide dispersion strengthened alloy, wherein the bushing comprises no welds. In a further aspect still, the present invention provides a bushing for glass fibre production comprising a platinum-group-metal-based oxide dispersion strengthened alloy, wherein the bushing comprises one or more nozzles and a main body, and wherein the one or more nozzles and the main body are part of a continuous article and/or wherein the one or more nozzles and the main body are not joined by a welded joint.

The invention will now be described in relation to the following non-limiting drawings in which:

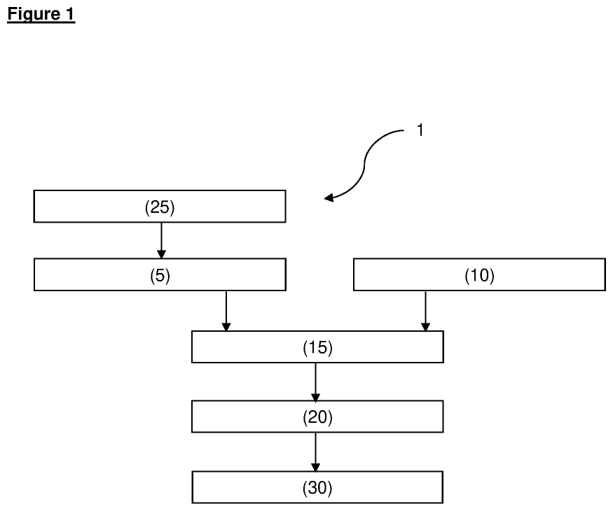

FIG. 1 is a flow chart of a method of additively manufacturing an article comprising an oxide dispersion strengthened alloy according to an aspect of the present invention.

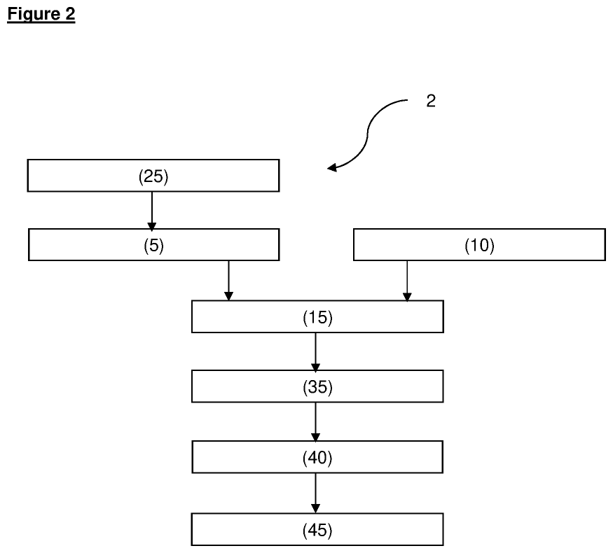

FIG. 2 is a flow chart of a method of additively manufacturing an article comprising an oxide dispersion strengthened alloy according to an alternative aspect of the present invention.

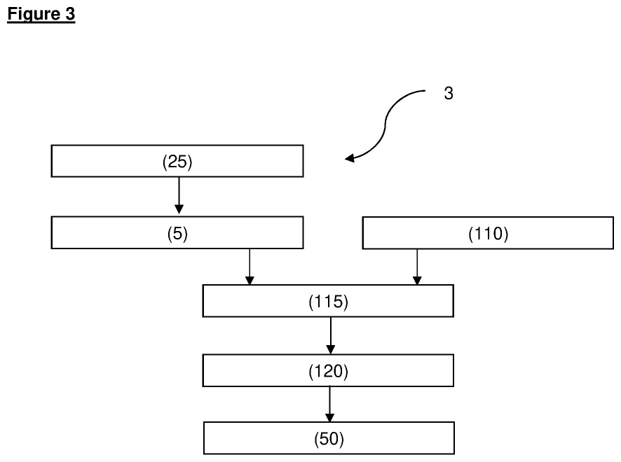

FIG. 3 is a flow chart of a method of additively manufacturing an article comprising an oxide dispersion strengthened alloy according to a further alternative aspect of the present invention.

Referring to FIG. 1, there is a shown a flow chart of a method of additively manufacturing an article comprising an oxide dispersion strengthened alloy according to an aspect of the present invention (shown generally at 1). The method comprises: 5 providing a first powder comprising particles of one or more platinum group metals or an alloy thereof; 10 providing a second powder comprising particles of one or more non-platinum-group metals or metalloids, or one or more alloys thereof; 15 providing a third powder by mixing the first powder and the second powder, the third powder comprising from 0.01 to 1 wt. % of the second powder, based on the total weight of the third powder; and 20 forming an article by a powder bed fusion method using the third powder in an atmosphere comprising from greater than 0 to 2 mol. % oxygen. Optionally, the method further comprises 25 a step of forming the first powder by atomizing one or more platinum group metals or an alloy thereof. Optionally, the method further comprises 30 a step of recovering the additively manufactured article.

Referring to FIG. 2, there is shown a flow chart of a method of additively manufacturing an article comprising an oxide dispersion strengthened alloy according to an alternative aspect of the present invention (shown generally at 2). The method comprises: 5 providing a first powder comprising particles of one or more platinum group metals or an alloy thereof; 10 providing a second powder comprising particles of one or more non-platinum-group metals or metalloids, or one or more alloys thereof; 15 providing a third powder by mixing the first powder and the second powder, the third powder comprising from 0.01 to 1 wt. % of the second powder, based on the total weight of the third powder; 35 providing an activated powder by heating the third powder in an atmosphere comprising from greater than 0 to 2 mol. % oxygen to a temperature sufficient to cause at least partial oxidation of the one or more non-platinum-group metals or metalloids, or one or more alloys thereof, but substantially no oxidation of the one or more platinum group metals or alloy thereof; and 40 forming an article by a powder bed fusion method using the activated powder in an inert atmosphere. Optionally, the method further comprises 25 a step of forming the first powder by atomizing one or more platinum group metals or an alloy thereof. Optionally, the method further comprises 45 a step of recovering the additively manufactured article.

Referring to FIG. 3, there is shown a flow chart of a method of additively manufacturing an article comprising an oxide dispersion strengthened alloy according to a further alternative aspect of the present invention (shown generally at 3). The method comprises: 5 providing a first powder comprising particles of one or more platinum group metals or an alloy thereof; 110 providing an oxide powder comprising particles of one or more oxides of a or a mixture of non-platinum-group metals or metalloids; 115 providing a mixed powder by mixing the first powder and the oxide powder, the mixed powder comprising from 0.01 to 1 wt. % of the oxide powder, based on the total weight of the mixed powder; and 120 forming an article by a powder bed fusion method using the mixed powder in an inert atmosphere. Optionally, the method further comprises 25 a step of forming the first powder by atomizing one or more platinum group metals or an alloy thereof. Optionally, the method further comprises 50 a step of recovering the additively manufactured article.

The invention will now be described with reference to the following non-limiting examples.

Articles were additively manufactured according to embodiments of the present invention. In particular, articles were additively manufactured according to the third aspect, i.e. the aspect according to claim 6. The articles were tested for Vickers hardness, ultimate tensile strength (UTS) and elongation at break using standard techniques. The techniques used here were according to ASTM E8/E8M. The oxidation rate, which is the weight loss percentage during 20 hours at 1550° C. in air, was also measured. The results were compared against conventional materials, and the results are shown in Table 1. A ‘C’ indicates that the material was casted (rather than by SLM). The ‘S’ indicates that the material was manufactured by SLM. The numbers indicate the relative amounts of the components of the alloy, in wt. %. For example, Pt-Rh10 is an alloy of platinum and rhodium, consisting of 10 wt. % rhodium and the balance platinum, together with any unavoidable impurities. The ODS alloy was manufactured using zirconia and yttria (i.e. zirconium oxide and yttrium oxide) to stabilise the alloy.

In particular, the S-ODS-PtRh10 was manufactured as follows. 1.5 kg of PtRh10 powder was gas atomised and pre-sieved to a D10 of 15 μm and a D90 of 54 μm. Yttria stabilised zirconia oxide powder was used as the second/oxide powder, having a D90<2 μm and being in an amount of 0.7 wt. % based on the total weight of the mixed powder. The mixed powder was blended in a tubular mixer for 30 minutes with 2 kg of steel ball media. The powder was removed and was tested to make sure the steel from the media did not contaminate the powder. SEM analysis was used to check the oxide was well dispersed in the Pt-Rh10. The material was then put into an EOS M100 additive manufacturing system and an article was built using a standard Pt-Rh10 parameter.

TABLE 1

| | Hardness | UTS | Elongation at | Oxidation |
|---|---|---|---|---|
| Material | (HV) | (MPa) | break % | rate (wt. %) |
| C-Pt-Rh10 | 115.7 ± 2.13 | 364.06 ± 2.31 | 35 | — |
| S-Pt-Rh10 | 132.7 ± 6.78 | 393.14 ± 11.02 | 40 | 0.1 |
| S-ODS-Pt- | 170.3 ± 8.2 | 493.8 ± 9.4 | 31 | 0.19 |
| Rh10 | | | | |
| S-Pt-Rh 17 | 170.1 ± 4.8 | 483.89 ± 3.44 | 40 | 0.1 |
| S-Pt-Rh 20 | 172.96 ± 3.1 | — | — | 0.1 |

It can be seen that the hardness and tensile strength of the additively manufactured article manufactured according to the present invention is significantly higher than that of an additively manufactured article having the same platinum group metal composition, but not being stabilised by oxides. Moreover, the hardness and tensile strength of the article according to the present invention is comparable to that of additively manufactured articles having significantly higher rhodium contents, such as 7 and 10 wt. % higher than the rhodium content of the additively manufactured article according to the present invention. Moreover, surprisingly, the oxidation resistance of the article of the invention is not significantly reduced compared to the comparative additively manufactured articles. In other words, advantageously, the use of oxide stabilisation acts in a similar manner to increasing the rhodium content. Since rhodium is very expensive, a similar or greater hardness and tensile strength may surprisingly be obtained by the present invention, but by using cheaper materials. The foregoing detailed description has been provided by way of explanation and illustration, and is not intended to limit the scope of the appended claims. Many variations in the presently preferred embodiments illustrated herein will be apparent to one of ordinary skill in the art and remain within the scope of the appended claims and their equivalents.

1. A method of additively manufacturing an article comprising an oxide dispersion strengthened alloy, the method comprising:
providing a first powder comprising particles of one or more platinum group metals or an alloy thereof;
providing a second powder comprising particles of one or more non-platinum-group metals or metalloids, or one or more alloys thereof;
providing a third powder by mixing the first powder and the second powder, the third powder comprising from 0.01 to 1 wt. % of the second powder, based on the total weight of the third powder; and
forming an article by a powder bed fusion method using the third powder in an atmosphere comprising from greater than 0 to 2 mol. % oxygen.

2. A method of additively manufacturing an article comprising an oxide dispersion strengthened alloy, the method comprising:
providing a first powder comprising particles of one or more platinum group metals or an alloy thereof;
providing a second powder comprising particles of one or more non-platinum-group metals or metalloids, or one or more alloys thereof;
providing a third powder by mixing the first powder and the second powder, the third powder comprising from 0.01 to 1 wt. % of the second powder, based on the total weight of the third powder;
providing an activated powder by heating the third powder in an atmosphere comprising from greater than 0 to 2 mol. % oxygen to a temperature sufficient to cause at least partial oxidation of the one or more non-platinum-group metals or metalloids, or one or more alloys thereof, but substantially no oxidation of the one or more platinum group metals or alloy thereof; and
forming an article by a powder bed fusion method using the activated powder in an inert atmosphere.

3. The method of claim 1 or claim 2, wherein the second powder comprises particles of one or more of cerium, tungsten, tantalum, hafnium, manganese, thorium, calcium, aluminium, zirconium and yttrium, or one or more alloys thereof.

4. The method of any of the preceding claims, wherein the second powder comprises particles of zirconium and/or yttrium and/or an alloy thereof.

5. The method of any of claims 2 to 4, wherein the third powder is heated to a temperature of from 400° C. to 950° C. for 2 hours or less.

6. A method of additively manufacturing an article comprising an oxide dispersion strengthened alloy, the method comprising:
providing a first powder comprising particles of one or more platinum group metals or an alloy thereof;
providing an oxide powder comprising particles of one or more oxides of a or a mixture of non-platinum-group metals or metalloids;
providing a mixed powder by mixing the first powder and the oxide powder, the mixed powder comprising from 0.01 to 1 wt. % of the oxide powder, based on the total weight of the mixed powder; and
forming an article by a powder bed fusion method using the mixed powder in an inert atmosphere.

7. The method of claim 6, wherein the oxide powder comprises particles of one or more oxides of a or a mixture of cerium, tungsten, tantalum, hafnium, manganese, thorium, calcium, aluminium, zirconium and yttrium.

8. The method of claim 6 or 7, wherein the oxide powder comprises one or more of cerium oxide, zirconium oxide, yttrium oxide, a zirconium-yttrium mixed oxide and a cerium-zirconium mixed oxide.

9. The method of any of the preceding claims, wherein the particles of the first powder have a D90 of 90 μm or less and/or the particles of the second or oxide powder have a D90 of 10 μm or less.

10. The method of any of the preceding claims further comprising a step of forming the first powder by atomizing one or more platinum group metals or an alloy thereof.

11. The method of any of the preceding claims, wherein the one or more platinum group metals or alloy thereof is a platinum group metal alloy, preferably comprising platinum and one or more of rhodium, ruthenium and iridium, together with any unavoidable impurities.

12. The method of claim 11, wherein the platinum group metal alloy comprises:
from 0.5 to 30 wt. % rhodium, preferably from 5 to 15 wt. % rhodium, more preferably from 8 to 12 wt. % rhodium; and
the balance platinum, together with any unavoidable impurities.

13. The method of claim 11, wherein the platinum group metal alloy comprises:
from 0.5 to 30 wt. % ruthenium; and
the balance platinum, together with any unavoidable impurities.

14. The method of claim 11, wherein the platinum group metal alloy comprises:
from 0.5 to 30 wt. % iridium; and
the balance platinum, together with any unavoidable impurities.

15. The method of claim 11, wherein the platinum group metal alloy comprises:
from 0.5 to 15 wt. % iridium;
from 0.5 to 15 wt. % rhodium; and
the balance platinum, together with any unavoidable impurities.

16. The method of any of the preceding claims, wherein the third powder is provided by mixing the first powder and the second powder in a powder mixer or wherein the mixed powder is provided by mixing the first powder and the oxide powder in a powder mixer, preferably for at least 30 minutes.

17. The method of any of the preceding claims, wherein the article is a bushing for glass fibre production.

18. The method of any of the preceding claims, wherein the article is for high-temperature applications.

19. An additively manufactured article manufactured by a method according to any of the preceding claims.

20. A bushing for glass fibre production comprising an additively manufactured article according to claim 19.
